(19) United States
(12) Patent Application Publication
(10) Pub. No.: US 2024/0161194 A1
(43) Pub. Date: May 16, 2024

(54) RETIREMENT ROAD MAP SYSTEM

(71) Applicants: ERIK SUSSMAN, FT LAUDERDALE, FL (US); DARREN SUSSMAN, FT LAUDERDALE, FL (US)

(72) Inventors: ERIK SUSSMAN, FT LAUDERDALE, FL (US); DARREN SUSSMAN, FT LAUDERDALE, FL (US)

(21) Appl. No.: 17/988,592

(22) Filed: Nov. 16, 2022

(51) Int. Cl. G06Q 40/06; G06Q 40/00

(52) U.S. Cl. CPC G06Q 40/06; G06Q 40/10

(57) ABSTRACT

A retirement plan roadmap system that is comprised of a computer processing system, a display that is operatively connected to the computer processing system, and input device that is operatively connected to the computer processing system. The computer processing system uses an application that will run a Monte Carlo Simulation on a prospect's investments with or without an adjustment. The application is programmed to have a growth bucket and a volatility bucket. The growth bucket has financial products that are potentially exposed to volatility over the life of a retirement plan. The volatility bucket has financial products that cannot go down in value and are not correlated to the growth bucket. The application is programmed to only take distributions from the growth bucket during up market years, and to only take distributions from the volatility bucket during down market years.

### BACKGROUND

The present invention is directed to a retirement roadmap system that will be used by a retirement plan sales associate to visually educate a retirement plan prospect on an effective retirement distribution plan.

The retirement roadmap system of the present invention is presented by the retirement plan sales associate to the prospect in six steps.

In the first step of the presentation 200, the sales associate builds an initial rapport with the retirement plan prospect, hereinafter “the prospect.” In this step, the sales associate builds a trusted relationship with the prospect while collecting information from the prospect that is imputed into the system.

In the second step of the presentation 300, the sales associate uses the system to educate the prospect on what should be considered when developing and effective retirement distribution plan. Things to consider are tax considerations, risks associated with investments, and the need to have a volatility buffer when making investments.

In step three of the presentation 400, the sales associate reviews with the prospect the information collected in the first step and ensures that the information is current. The sales associate also uses the information collected to help the prospect determine the highest retirement budget that the prospect can utilize in his or her retirement plan while at the same time leaving the prospect with sufficient financial resources to live comfortably.

In step four of the presentation 400, the sales associate educates the prospect on how the system works to maximize the retirement distributions that are placed in the retirement plan, and how the system protects the retirement plan during down years. The sales associate does this by running a dual simulation that will predict the growth & distribution of the retirement plan with or without adjustments. The sales associate also educates the prospect that the system uses a growth bucket to distribute in the retirement plan during up market years and a volatility bucket to distribute from the retirement plan during down market years. The sales associate further educates the prospect that the system uses the Monte Carlo Simulation algorithm to determine a long-range effective retirement distribution plan strategy.

In step five of the presentation 500, the sales associate reviews the visual results of the simulation with the prospect. In the visual review of the simulation, a numerical score is given by the system to the before and after adjustment retirement distribution plan strategy. In this step, the sales associate shows the prospect how the volatility bucket is utilized by the system to ensure the maximum distributions of the retirement plan.

In step six of the presentation 600, the sales associate, using the system, explains the most effective retirement distribution plan strategy to the prospect and guides the prospect in selecting the most effective retirement distribution plan strategy.

The present system is developed to educate the prospect as to the how and the why of his or her retirement plan strategy, while simultaneously providing the sales associate with a tool that will help him or her help the prospect in a manner that will most benefit the prospect.

The present invention is directed to a system that helps the sales associates competently present a retirement plan distribution strategy to the prospect. The system is needed to protect prospects from incompetent sales associates. The system also helps sales associates present viable retirement distribution plan strategies to the prospect.

### SUMMARY

The present invention is directed to a retirement roadmap system that is used by a retirement plan sales associate to visually educate a retirement plan prospect.

The retirement plan roadmap system is comprised of a computer processing system, a display that is operatively connected to the computer processing system, and input device that is operatively connected to the computer processing system. The computer processing system uses an application that will run a Monte Carlo Simulation on a prospect's investment with or without an adjustment. The application is programmed to have a growth bucket and a volatility bucket. The growth bucket has financial products that could have volatility over the life of a retirement plan. The volatility bucket has products that cannot go down in value and are not correlated to the growth bucket. The application is programmed to only take distributions from the growth bucket during up market years, and to only take distributions from the volatility bucket during down market years. The system is a tool that teaches the investor of the need of having both a growth bucket and a volatility bucket in an effective retirement distribution plan and how the buckets will be used during the life of the retirement plan investment.

The present invention is a tool that helps financial professionals educate a prospect on the need of having a volatility buffer “a safe bucket” to protect their retirement plan investment. The system runs simulations that use the retirement plan investment with and without the safe bucket. The simulations are visually presented to the prospect prior to the financial professional closing the retirement plan client. The simulations are given a numerical score that will reflect the possibilities of success based on each simulation.

The novelty of the present invention is that is provides a retirement roadmap system that uses an algorithm to only pull distributions from the growth bucket in up market years and to only pull from the volatility bucket or the safe bucket in down market years. By using this algorithm, the client is given the greatest chance of having enough retirement income upon or after his or her retirement.

The object of the present invention is to provide a retirement roadmap system that will educate a retirement plan prospect on a sound retirement investment & distribution strategy.

Another object of the present invention is to provide a retirement sales associate with a tool that will allow him or her to present a retirement investment & distribution strategy to a retirement plan prospect.

Still another object of the present invention is to provide a retirement sales associate with a tool that will prevent him or her from presenting a flawed retirement investment & distribution strategy to a retirement plan prospect.

Yet still another object of the present invention is to provide a record of a retirement investment & distribution plan provided to a retirement plan prospect.

### BRIEF DESCRIPTION OF THE DRAWINGS

These and other features, aspects, and advantages of the present invention will become better understood with regards to the following description, appended claims, and drawings where:

FIG. 1 is a diagram that provides an overview of the present invention; and

FIG. 2 is a flowchart that shows you how the sales associate uses the present invention.

### DESCRIPTION

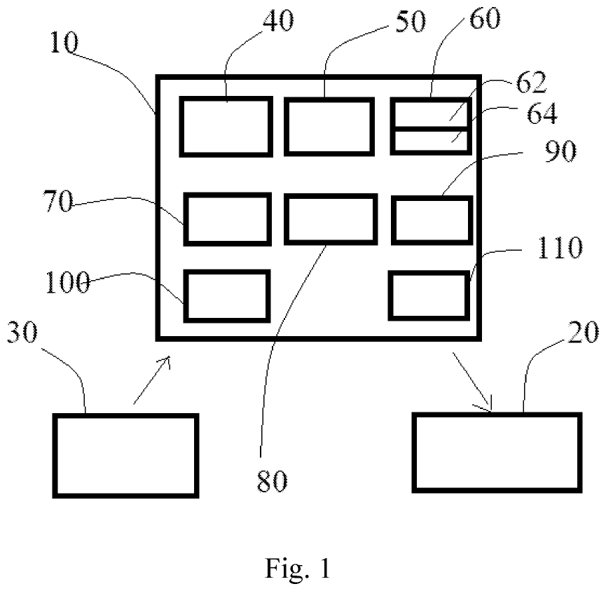

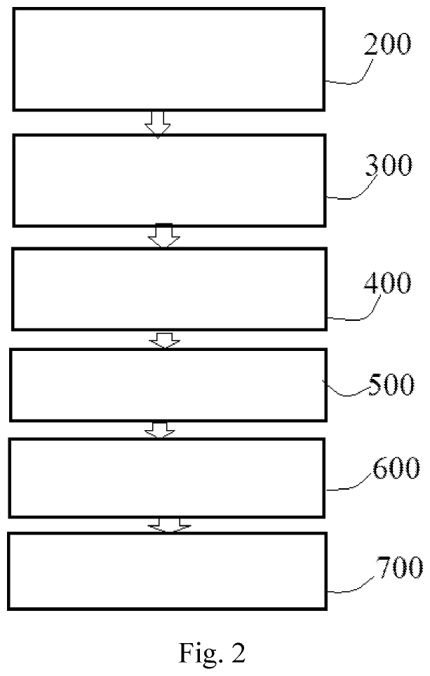

As seen in FIGS. 1-2, the present invention is a retirement road map system that is used by sales associates to maximize the chances that a retirement plan prospect will secure a retirement plan.

The retirement plan road map system comprises a computer processing system 10 that is configured to receive a prospect's input, to save the prospect's input, to separate the prospect's input into a plurality of buckets, to receive an adjustment that will be added or subtracted to the prospect's input, to run a simulation that predicts a future growth & distribution of the prospect's input with and without the adjustment, and to provide a visual representation of the simulation that predicts the future growth & distribution. A display 20 that is operatively connected to the computer processing system 10. An input device 30 that is operatively connected to the computer processing system 10, the input device is configured to allow the sales associate to input a prospect's input, to input the adjustment, to instruct the computer processing system 10 to run the simulation that predicts the future growth & distribution of the prospect's input with or without the adjustment, and to instruct the computer processing system 10 to show the visual representation of the simulation that predicts the future growth & distribution on the display 20. A prospect input module 40 that is operatively connected to the computer processing system 10, the prospect input module 40 is configured to receive and save the retirement plan prospect's basic personal information and financial information. An educational module 50 that is operatively connected to the computer processing system 60 that is configured to educate the retirement plan prospect, the educational module 50 is configured to run after the prospect input module 40 is utilized by the sales associate. A plurality of buckets module 60 that is operative connected to the computer processing system 10, the plurality of buckets module 60 has a growth bucket 62 and a volatility bucket 64, the plurality of buckets module 60 is configured to only allow the growth bucket 62 to run in the simulation that predicts the future growth & distribution of the prospect's input during an up market year and to only allow the volatility bucket 64 to run in the simulation that predicts the future growth & distribution of the prospect's input during a down market year. An adjustment module 70 that is operatively connected to the computer processing system 10, the adjustment module 70 is configured to allow the sales associate to select either the growth bucket 62 or the volatility bucket 64 prior to running the simulation that predicts the future growth & distribution of the prospect's input. A simulation module 80 that is operatively connected to the computer processing system 10, the simulation module 80 uses a Monte Carlos Simulation to run the simulation that predicts the future growth & distribution of the prospect's input with or without the adjustment, the simulation module 80 receives the instruction to run the simulation that predicts the future growth & distribution and to publish a plurality of data that corresponds to the simulation that predicts the future growth & distribution on the display 20, the simulation module 80 is configured to save the simulation that predicts the future growth & distribution so that the sales associate can guide the retirement plan prospect with an effective retirement plan strategy. A review module 90 that is operatively connected to the computer processing system 10, the review module 90 is configured to provide the sales associate with the plurality of data that is generated by the simulation module 80 that the sales associate uses to educate the retirement plan prospect on the effective retirement plan strategy. And, a closing module 100 that is operatively connected to the computer processing system 10, the closing module 100 is configured to allow the salesman to record a retirement strategy that has been selected by the retirement plan prospect.

In an embodiment of the present invention, a retirement road map system 100 has a follow up module 110 that is configured to allow the sales associate to schedule a future meeting with the retirement plan prospect.

The buckets contain financial products. In a preferred embodiment of the present invention, the volatility bucket contains financial products that cannot go down in value and are not correlated to the growth bucket.

An advantage of the present invention is that it provides a retirement roadmap system that teaches a retirement plan prospect to select a sound retirement investment & distribution strategy.

Another advantage of the present invention is that it provides a retirement sales associate with a tool that allows him or her to present a retirement investment & distribution strategy to a retirement plan prospect.

Still another advantage of the present invention is that it provides a retirement sales associate with a tool that prevents him or her from presenting a flawed retirement investment & distribution strategy to a retirement plan prospect.

Yet still another advantage of the present invention is that it provides a record of a retirement investment & distribution plan provided to a retirement plan prospect.

A further advantage of the present invention is that the retirement plan road map system can make a client's money last longer in retirement because of the volatility buffer strategy.

The embodiments of the retirement roadmap system are exemplary and numerous modifications, combinations, variations, and rearrangements can be readily envisioned to achieve an equivalent result, all of which are intended to be embraced within the scope of the appended claims. Further, nothing in the above-provided discussions of the retirement roadmap system, should be construed as limiting the invention to an embodiment or a combination of embodiments. The scope of the invention is defined by the description, drawings, and appended claims.

What is claimed is:

1. A retirement road map system that is used by sales associates to maximize the chances that a retirement plan prospect will secure a retirement plan, the retirement plan road map system comprises:
a computer processing system that is configured to receive a prospect's input, to save the prospect's input, to separate the prospect's input into a plurality of buckets, to receive an adjustment that will be added or subtracted to the prospect's input, to run a simulation that predicts a future growth & distribution of the prospect's input with and without the adjustment, and to provide a visual representation of the simulation that predicts the future growth & distribution;
a display that is operatively connected to the computer processing system;
an input device that is operatively connected to the computer processing system, the input device is configured to allow the sales associate to input a prospect's input, to input the adjustment, to instruct the computer processing system to run the simulation that predicts the future growth & distribution of the prospect's input with or without the adjustment, and to instruct the computer processing system to show the visual representation of the simulation that predicts the future growth & distribution on the display;
a prospect input module that is operatively connected to the computer processing system, the prospect input module is configured to receive and save the retirement plan prospect's basic personal information and financial information;
an educational module that is operatively connected to the computer processing system that is configured to educate the retirement plan prospect, the educational module is configured to run after the prospect input module is utilized by the sales associate;
a plurality of buckets module that is operative connected to the computer processing system, the plurality of buckets module has a growth bucket and a volatility bucket, the plurality of buckets module is configured to only allow the growth bucket to run in the simulation that predicts the future growth & distribution of the prospect's input during an up market year and to only allow the volatility bucket to run in the simulation that predicts the future growth & distribution of the prospect's input during a down market year;
an adjustment module that is operatively connected to the computer processing system, the adjustment module is configured to allow the sales associate to select either the growth bucket or the volatility bucket prior to running the simulation that predicts the future growth & distribution of the prospect's input;
a simulation module that is operatively connected to the computer processing system, the simulation module uses a Monte Carlos Simulation to run the simulation that predicts the future growth & distribution of the prospect's input with or without the adjustment, the simulation module receives the instruction to run the simulation that predicts the future growth & distribution and to publish a plurality of data that corresponds to the simulation that predicts the future growth & distribution on the display, the simulation module is configured to save the simulation that predicts the future growth & distribution so that the sales associate can guide the retirement plan prospect with an effective retirement & distribution plan strategy;
a review module that is operatively connected to the computer processing system, the review module is configured to provide the sales associate with the plurality of data that is generated by the simulation module that the sales associate uses to educate the retirement plan prospect on the effective retirement plan strategy; and
a closing module that is operatively connected to the computer processing system, the closing module is configured to allow the salesman to record a retirement strategy that has been selected by the retirement plan prospect.

2. The retirement road map system that is used by the sales associates to maximize the chances that the retirement plan prospect will secure the retirement plan of claim 1, the retirement map system comprises a follow up module that is configured to allow the sales associate to schedule a future meeting with the retirement plan prospect.
